(19) United States
(12) Patent Application Publication
(10) Pub. No.: US 2003/0147232 A1
(43) Pub. Date: Aug. 7, 2003

(54) Remote light source general lighting system

(75) Inventor: Edward Robert Kraft, New York, NY (US)

Correspondence Address: FISH & NEAVE, 1251 AVENUE OF THE AMERICAS, 50TH FLOOR, NEW YORK, NY, 10020-1105, US

(73) Assignee: Opti-Flux Technologies, Las Vegas, NV (US)

(21) Appl. No.: 10/066,476

(22) Filed: Feb. 2, 2002

(51) Int. Cl. F21V 7/04

(52) U.S. Cl. 362/31; 362/554; 362/576; 362/580

(57) ABSTRACT

A general lighting system has been created to collect light from a high efficiency light source, concentrate the light into a flux with a tapered light guide, transport the light flux via a large diameter hexagonal light pipe to the edge of a light emitting flat panel. The light panel emits the light remote from the light source. The light source may use high intensity discharge lamp or combination of lamps to provide a light flux that is efficiently generated and balanced for the desired color. A hollow, tapered light pipe concentrator made of polished reflective heat resistant material, concentrates the light flux into an area of transmission output. The light flux is transported via a solid plastic hexagonal light pipe. The light flux is fed to the edge of a light emitting flat panel. The system is specifically created to replace fluorescent light luminairs. The system is specifically designed to provide general or task lighting in any application that would normally use a fluorescent, filament or arc type light bulb without the inherent limitations of usual light sources such as space requirements, heat generation, environmental temperature, moisture sensitivity, possible explosive ignition and/or crush or explosion due to hypo or hyper baric pressures.

U.S. Patent Documents

| | | | |
|---|---|---|---|
| 4422719 | December, 1983 | Orcutt | 385/123. |
| 4460940 | July, 1984 | Mori | 362/558. |
| 4471412 | September, 1984 | Mori | 362/565. |
| 4822123 | April, 1989 | Mori | 385/31. |
| 4765701 | August, 1988 | Cheslek | 362/560. |
| 5222795 | June, 1993 | Hed | 362/558. |
| 5826669 | November, 1998 | Hed | 362/92. |
| 6210013 | April, 2001 | Boufeild | 362/92. |

### STATEMENT REGARDING FEDERALLY SPONSORED RESEARCH AND DEVELOPMENT

The subject invention was not funded in any part by the United States Government. All rights are retained by the inventor for his sole use.

### BACKGROUND OF THE INVENTION

Remote illumination is widely held to be more energy efficient than traditional fluorescent tube illumination systems simply by utilizing lamps that produce more lumens per watt of power and removing or reusing the heat generated by the light source. The light source can be mounted in areas of easy access while the light emitting component can be in inaccessible or inhospitable locations.

A practical system of remote illumination for general and task lighting is dependent on the materials and methods to transport large amounts of light flux to an area and then emitting the light flux in a controlled even manner.

Numerous applications of optical fiber bundles for illumination are known. In most cases the fiber bundle is simply used to conduct the light to the remote location and the light is emitted from the open end of these fibers. The light flux carrying capacity of traditional fiber optic bundles limit their use. Light from a readily available high output lamp cannot be concentrated enough to be transmitted by a single fiber. Multiple fiber bundles are then required and their cost is prohibitive for general lighting applications.

The invention herein describes a system that generates a large amount of light flux and transfers that light to a panel that can emit a large amount of light flux in a controlled manner over a flat surface. The system utilizes a light pipe of sufficient cross sectional dimension to conduct the light flux from an efficient light source and light source concentrator.

The ability to generate and transport light flux is within the public domain. The ability to extract large amount of light flux from a flat panel in a controlled method remote from the light source is unique to this system and has been the subject of prior art.

Cheslek U.S. Pat. No. 4,765,701 uses discrete elements to extract light from an optical fiber in conjunction with a panel. Cheslek uses angular recesses and does not provide for means to control quantitatively the light extraction, and as a result, the illumination from the downstream (distal) recesses is progressively lower.

Hed U.S. Pat. No. 5,222,795 proposed a curve linear tapering of the cross sectional area of a fiber optic and abrading or painting the flattened surface. The amount of light extracted is limited by the size of the fiber. Hed in U.S. Pat. No. 5,836,669 then proposed the application or elongated triangular reflective stripes onto a plastic plate. The tapering of the fiber optics provided a one way illumination with a substantial amount of light that could not be extracted from the distal end of the tapered fiber perpendicular to the emitting plate face. The painted triangle method does not allow enough emitting area to make the light emitted practical for general illumination. The light injection end in both these applications does not provide enough distance for an even light flux and would cause a bright spot at the injection end. This condition on Hed's flat panel application is overcome by making the injection end part of the triangle very narrow and starting the installation of that triangle far from the emitting edge of the panel and thus further limiting the emitting surface.

Bousfeild U.S. Pat. No. 6,210,013, proposes a matrix of dots with increased diameters as they lay distal to the light injecting edge on a flat panel. This method is again limited by the actual area of reflectance.

The prior art as described is a two dimensional light propagation over a flat panel and thus the light output is limited by the actual area of the reflecting coating or treatment. The Light Emitting Panel herein described uses irregular tapered tetrahedron grooves that have a surface area on at least two sides that is increased as it runs distal from the injection edge of the panel. The amount of light emitted is determined by the surface area and reflectance of the grooves and the treatment of the groove walls.

### FIELD OF THE INVENTION

My present invention relates to the efficient generation, collection, concentration and transportation of light flux to a light emitting panel. The light emitting panel provides controlled light extraction from light guides cast, imbedded or machined into base glass or plastic panels that are fed light from a remote source. Light is emitted from the panel from the surface of the light guides within the panel. The surface area of the light guides increases as they lay further from the light input end. The interior emitting surface of the light guides are treated to cause light refraction on their surface. Light is either emitted directly from the light guide surface through the face of the panel or from the reflected light from the back of the panel.

A tapered light guide that has the shape and size of the light flux transporting light pipe on one end and the shape and size of the light panel on the other end provides an area where light flux is arranged by total internal reflection to preserve the light flux etendue and distribute the light evenly across the light input edge of the light emitting zone.

The subject invention was created to replace fluorescent lighting luminairs or applications with a remote light source device to overcome the space requirements, heat production, maintenance requirements, and application limitations of common light sources.

### OBJECTS OF THE INVENTION

The first principal object of the invention is to provide a system for generating light in an efficient manner and emitting the light remotely from the source.

The second principal object of the invention is to provide a method of and means for extracting light from an edge lit panel in a controlled manner so that drawbacks of earlier illuminating systems using other light guides are avoided. The panels are fabricated in sizes to take the place of fluorescent bulb luminairs. Once this method of light extraction was developed, large light sources could be coupled with large light pipes to generate and transport the light flux to a remote location. Several light panels can be optically connected to the light source.

Another object is to provide a lighting system where a high efficiency light source can be coupled to one or more light emitting panels without using traditional fiber optic bundles.

Another object is to provide a light pipe system that can transport large amounts of light flux to multiple locations from a single light source. The light pipe is configured in a hexagonal prismatic shape that preserves the light source light flux etendue.

Another object is to provide a high efficiency light source that utilizes available high efficiency bulbs to generate light in the most efficient way possible without the limitations and light loss caused by concentration and heat when coupled to plastic light pipes.

It is yet another object of the invented system to provide a light source that may use several different light bulb types to mix the various light outputs of the various bulbs to render the desired color balance without filters or restrictions.

It is a further object of the invented system to utilize readily available high efficiency light bulbs of differing sizes and shapes to be concentrated into an output light flux that has a coherent wave front.

### SUMMARY OF THE INVENTION

These objects and others which will become apparent hereinafter are attained, in accordance with the present invention in a method of illuminating an area which comprises the steps of:

(a) Generate light with an efficient light source bulb or combination of bulbs,

(b) Concentrate the light flux generated with and efficient tapered light pipe concentrator,

(c) Transport the light in an efficient manner with a hexagonal light pipe,

(d) Emit the light flux in a uniform manner over a surface.

### BRIEF DESCRIPTION OF THE DRAWINGS

The above and other objects, features and advantages of the present invention will become more readily apparent from the following description, reference being made to the accompanying drawing in which:

FIG. 1 is a perspective view from the back of the general lighting luminaire to be placed in a hung ceiling system showing the light guides, silicone and mirror reflectors and the tapered light guide injection area that is bent parallel to the light panel to facilitate connection to a supply light pipe for use in a confined drop ceiling application.

FIG. 2 is a larger cross section of the light guides cut into the light panel with the reflective paint layer applied into the grooves, the RTV Silicone layer and the mirror layer.

FIG. 2-A shows the relative depth of the groove cut from the small cross sectional area at the proximal end of the panel.

FIG. 2-B shows a larger cross sectional depth at the distal end of the panel.

FIG. 3 is a perspective view showing the geometric shape of the light guide within the light panel.

FIG. 4 is a perspective diagram viewed from above the ceiling of a remote lighting system with a light source, light pipes and light emitting luminairs.

FIG. 4-A is a plan view of the dual light source showing the tapered light concentrator and ventilation.

FIG. 4-B is a side section view of the dual light source showing the metal halide and the high pressure sodium bulbs in place next to each other within the tapered light concentrator.

FIG. 4-C shows the emitting end of the light source with a clear plastic window that is the ground for the optical connections with the light pipe.

### DETAILED DESCRIPTION OF THE INVENTION

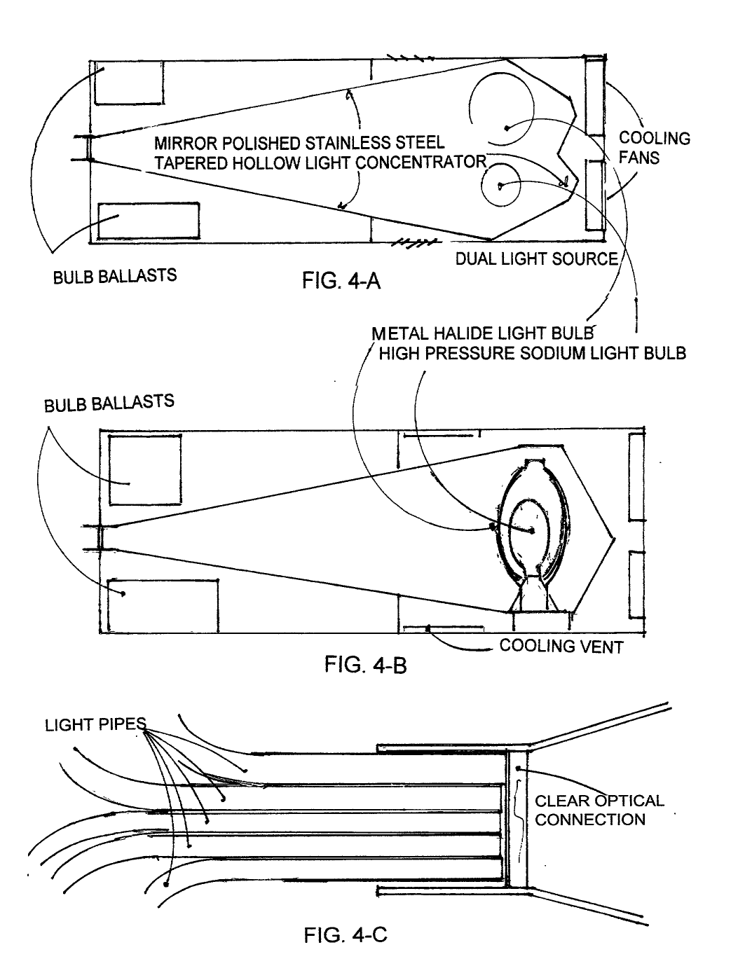

FIG. 4 illustrates the invented system in that light can be generated, concentrated, transported and emitted remotely from the original light source. Light generation by readily available lamps and concentration by a lens systems or tapered concentrators is within the public domain. What is unique to this light source for this particular application is the coupling of two or more different high efficiency lamp types within one light source to balance the light output from the individual lamps to obtain the desired light color and to improve the color rendering of the emitted light from the combination of the lamps. Full spectrum light is desirable in most general lighting applications.

It is well known that that HID lamp types, such as metal halide and high pressure sodium, emit light much more efficiently than fluorescent or incandescent lamps as related to the lumens per watt ratio. It is also widely known that as the wattage of these lamps is increased, the efficiency is also increased. HID lamps in general do not emit a balanced light color and are generally not used indoors for general lighting. Metal halide lamps tend to emit light in the cooler, blue ranges, while high pressure sodium lamps emit light in the warmer red-yellow ranges. Manufacturers have coated or filtered the emitted light by treating the outer globe of the lamps or have changed the lamp gas mixture to produce a wider more balanced light spectrum. The filtering and treatment or altering the gas mixture usually produces a more balanced color but reduces the light output efficiency of the lamp.

Two or more lamps with different light color emissions are combined so that the additive nature of light allows the sum total of the light output of the individual lamps to be more balanced across the visible light spectrum without filtering. Two or more unfiltered high efficiency bulbs are selected for their complimentary light output, and combined within a light concentrator light source to generate a full color spectrum of light. The resulting combination of lamps produces a light flux that is generated in the most efficient manner available and color balanced for the most desired effect. FIGS. 4-A, 4-B, 4-C shows a tapered hollow hexagonal light pipe concentrator.

HID lamps are energy efficient but also radiate heat. Parabolic reflectors concentrate the visible and infrared light output from a lamp to a focal point. The resulting focal point of light energy produces a focused point of heat. This condition limits the use fiber optic and light pipe materials made of plastic. Additionally, it is widely known within the art of non-imaging optics, that any fiber optic bundle coupled within the focal point of a light source with a parabolic reflector will yield a situation where the center fibers within the bundle receive more light flux energy than the fibers laying outside the focal point of the parabolic reflector. This situation is undesirable when transporting large amounts of light flux.

The tapered hollow hexagonal light pipe concentrator yields a light flux that is more evenly distributed across the emitting output end of the tapered light pipe. The tapered light pipe concentrator is of sufficient length to average all the light rays and dissipate the heat from the light bulbs within. The hexagonal shape at the output end of the concentrator yields a shape that can be filled with large cross sectional hexagonal light pipes while maintaining an efficient packing area for the transporting light flux light pipe.

It is widely known that round and many other regular polygon shaped light pipes do not provide an even distribution of light across there emitting face. The use of a hexagonal (or square) prismatic shaped light pipe yields a very even distribution across the entire emitting face. This effect is desirable to maintain the light flux etendue. The subject light pipe is made of clear polymethylmethacrylate fabricated in a hexagonal prismatic shape.

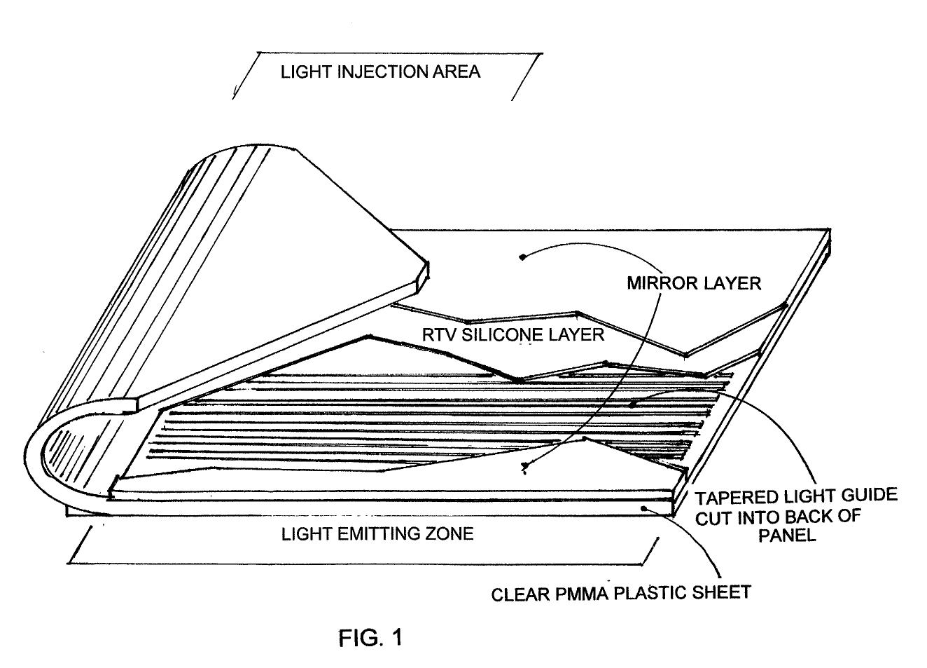

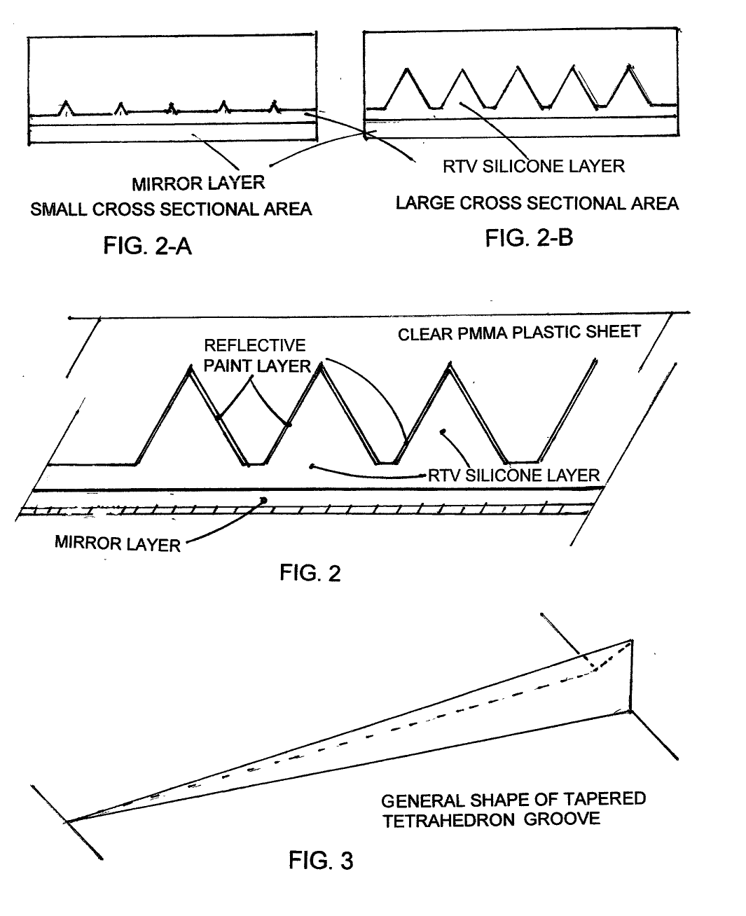

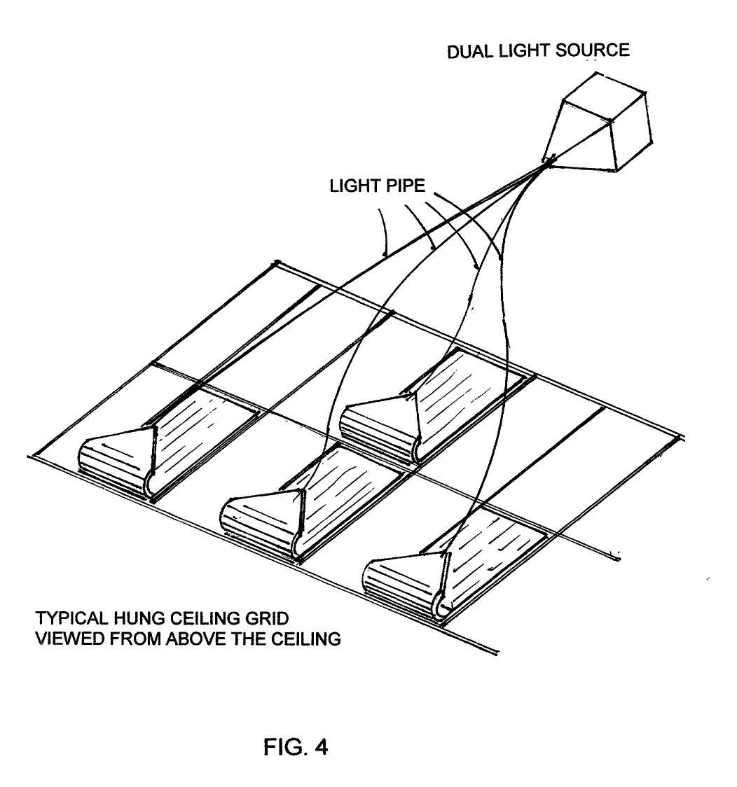

FIG. 1 shows two general areas of the light emitting panel; the tapered injection area and the light emitting zone. Light entering the tapered light injection area can be from any light source and can be conducted by any fiber optic or light pipe system; in this instance a hexagonal plastic light pipe.

Light flux enters the tapered light guide area from the light pipe and as such is highly organized as a flux rather than a beam. The tapered light guide provides an area where the light flux can be evenly averaged and distributed across the proximal end of the emitting area of the light emitting panel by internal reflection. Once the light flux enters the light emitting area, it encounters areas of refraction and reflection light guides that are cut or cast into the light panel on one side. These refraction/reflection light guides have an increased surface area as they lay more distal to the light flux injection area.

As the light flux travels parallel to the light refraction/reflection side and the emitting side the refraction/reflection light guide areas disrupt the light flux organization and cause skew rays to be emitted opposite the refraction/reflection side of the light panel. The light flux loses intensity as it travels though the panel and is emitted from the panel. The increased surface area of the refraction/reflection areas compensates for the light intensity loss as it travels through and emitted from the panel and thus light is emitted uniformly from the panel from the injection end to the distal end.

Excess light that is not emitted from the panel and travels to the distal perpendicular edge is reflected back into the panel.

It should be obvious to those skilled in the art that in practicing this invention, and designing extraction system with available intensity along the extraction zone, it is preferred to position the zones of higher luminosity closer to the proximal end and the zones of lower luminosity near the distal end of the extraction zone, when the direction of light propagation is from the proximal to the distal end.

While I have described a number of embodiments here, it will be understood that all of the features specific to one embodiment can be used, to the extent compatible, in any other and that the invention also embraces all new and unobvious features individually and in combination within the spirit and scope of the appended claims.

I claim:

1. A remote illumination system has been created comprising:
a high efficiency light source and light flux concentrator;
an optical light pipe for transporting light flux from said light source;
a tapered light guide that couples the light flux form the transporting light pipe to a light emitting luminaire;

2. The light source uses one or more high intensity discharge (HID) lamps or other light source housed in a heat resistant, hollow, tapered light pipe concentrator. The interior of the light pipe concentrator is polished or treated to produce a high internal reflectance:
(a) The lamp or combination of lamps, may be utilized to produce a high efficiency generation of light.
(b) A combination of lamps or lamp type may be used to balance the color of the light flux produced by the light source.
(c) The light source concentrator section is of sufficient length to dissipate the secondary radiant heat from the source lamp or lamps.
(d) The narrow end of the light concentrator section is transparent and designed to accept and be optically connected to at least one light pipe.

3. At least one light pipe is optically connected to the light source. The light pipe can be made from polymethylmethacrylate (PMMA), glass, or other material that can transmit light flux. It may also be hollow with a reflective interior.
(a) The light pipe may be round, square, hexagonal, or any other regular prismatic shape.
(b) The light pipe may be configured to be branched into progressively smaller branches.
(c) The light pipes are of an adequate cross sectional area to permit large amounts of light flux transportation without generating a secondary energy other than visible light.
(d) The light pipes can be bent to a radius of ten times the one half cross sectional dimension.
(e) The light pipe is optically connected to the light flux organizational tapered light guide section of a light emitting light panel.

4. A lighting luminaire device has been created by casting or machining at least one irregular tetrahedron light guide into a flat rectangular plastic such as polymethylmethacrylate (PMMA), glass, or other material that can transmit light flux.
(a) That the surface of the embedded light guide is abraded, etched and/or treated to affect light refraction on the bounty between the base panel material and the imbedded light guide.
(b) That the light guide (s) has a progressively larger cross sectional area and increasing surface area as it lays more distal to the light injection edge. That light flux is organized and injected into the emitting region of the luminaire via a light flux organizational light guide section into at least one edge of the light panel and causing the light flux entering the emitting region to be organized and evenly distributed across the light injection edge of the luminaire emitted in a uniform fashion across the light panel:
(c) providing at least one elongated imbedded tapered light guide having a surface so structured with respect to the base panel thereof as to enable said light guide to transmit light along the light guide while said periphery prevents substantial emanation of light from said light guide in a direction transverse to said light guide;
(d) modifying a portion of said periphery over an extraction zone of said light guide to impart a generally tapered irregular tetrahedron shape to said zone extending continuously from a cross sectionally small end to a cross sectionally large end thereof and so that light traveling through said core in a propagation direction from said small end to said large end will emanate in an emanation direction transversely to said propagation direction, said zone narrowing in width in a spreading direction transversely to said propagation direction and to said emanation direction whereby an area exposed to said light emanating from said light guide is illuminated continuously along said length of said zone; and
(e) injecting light into said light guide ahead of said narrow end so that the light propagates in said propagation direction whereby said area is illuminated.

5. The method defined in claim 4 whereby said light guide is machined or cast into the base panel material and said light guide is generally an irregular tetrahedron having an increased surface area as it lays distally to the light injection edge.
(a) The surface of the embedded light guide may have additional smaller surfaces with the general irregular tetrahedron shape to provide more surface area of light emission.
(b) The method defined in claim 4, further comprising the step of rendering a surface of said light guide which is exposed over said zone diffusively light emissive.
(c) The method defined in claim 4 wherein said surface is rendered diffusively light emissive by abrading said surface, coating said surface or chemically treating said surface.

6. A system that provides illumination from a remote light source via a transporting light pipe. Light flux is injected into at least one edge of the light emitting panel from the edge that is perpendicular the small end of the embedded light guides. That the light flux is injected parallel to the light guides.
(a) The light flux is injected via a tapered light pipe area optically attached or part of the base panel material. That this tapered light pipe is of sufficient length to preserve the light source radiant flux density over the area of the light injecting edge of the light panel. The tapered light pipe injector provides angular averaging of the input light flux and provides a method of traversing the input light flux from the transporting light pipe while maintaining the etendue from the transporting light pipe.
(b) The tapered light pipe injector is an integral part of the light panel system as it provides a coupling area to provide a uniform distribution of light flux from a light supply pipe of one shape and size attached to a light source and the light panel of another shape and size.
(c) The tapered light pipe injector has one end that is the shape and size of the light flux transporting light pipe and the other end that is the shape of the light panel.
(d) The tapered light pipe injector area organizes the light flux in a uniform manner across its coupling area and eliminates high light intensity areas (“hot spots”) at the light input end of the light panel.
(e) The tapered light pipe injector may be bent over a radius of 10 times its ½ thickness.

7. The luminaire is specifically designed to provide general or task lighting in any application that would normally use a fluorescent, filament or arc type light bulb without the inherent limitations of usual light sources such as space requirements, heat generation, environmental temperature, moisture sensitivity, possible explosive ignition and/or crush or explosion due to hypo or hyper baric pressures.
(a) The ambient operating moisture, chemical and/or temperatures of the luminairs are only limited by the properties of the base plastic or glass materials used.
(b) No heat is generated from the luminaire and can be used in explosive environments.
(c) The luminaire is fashioned from a solid plastic or glass panel and is unaffected by operating pressures. The luminaire could operate in extreme hypo and hyper baric conditions without exploding or crushing.
(d) The luminaire can be fashioned to fit into existing or new “T” grid drop ceilings for use in residential or commercial office lighting.
(e) The luminaire could be permanently sealed into place in clean room air plenums and do not require removal for servicing as there are serviceable parts.
(f) The luminaire has no replaceable parts and is ideally suited for areas that are inaccessible or where access would create a problem such as back lit billboards. The light emitting surface can be manufactured in very large sections and would be ideally suited for any large exterior back lit signage. The emitting surface could be etched, painted, silk screened or laminated with normal signage materials
(g) The luminaire can be surface mounted or hung.

8. The light source is remote from the subject luminaire.
(a) The heat generated from the light source could be discarded to lower air conditioning requirements or recycled to provide heat for other uses.
(b) Access to the interior of the light emitting panel is not required for maintenance.
(c) The light emitting panel can be used in explosive atmospheres.
(d) The light panel can be used in caustic atmospheres
(e) The light emitting panel is unaffected by atmospheric or ambient pressure or pressure changes.

9. The light panel service temperature is only defined by the materials that it is composed of.
(a) Using alternate base materials with the same inherent optical properties can extend the service temperatures to the extremes found in outer space.
